(19) United States
(12) Patent Application Publication
(10) Pub. No.: US 2023/0210172 A1
(43) Pub. Date: Jul. 6, 2023

(54) A Cartridge for a Vapour Generating Device

(71) Applicant: JT International SA, Geneva (CH)

(72) Inventors: Simeon Williamson, Versoix (CH); Andrew Robert John Rogan, Forres (GB)

(73) Assignee: JT International SA, Geneva (CH)

(21) Appl. No.: 18/008,807

(22) PCT Filed: Jun. 7, 2021
(86) PCT No.: PCT/EP2021/065126

§ 371 Date: Dec. 7, 2022

(30) Foreign Application Priority Data
Jun. 10, 2020 (EP) 20179360.1

(51) Int. Cl. A24F 40/42; H05B 6/10; A24F 40/485; A24F 40/465; A24F 40/10

(52) U.S. Cl. CPC A24F 40/42; H05B 6/105; A24F 40/485; A24F 40/465; A24F 40/10

(57) ABSTRACT

A cartridge (10, 72) for a vapour generating device comprises an inductively heatable susceptor (54) and a porous liquid transfer element (56) configured to convey vapour generating liquid to the inductively heatable susceptor (54). The porous liquid transfer element (56) has a longitudinal axis (57) and defines an airflow channel (62) extending substantially in a longitudinal direction defined by the longitudinal axis (57). The porous liquid transfer element (56) also includes a recess (60), and at least part of the inductively heatable susceptor (54) is accommodated in the recess (60) and at least part of the inductively heatable susceptor (54) is accommodated in the airflow channel (62).

### TECHNICAL FIELD

The present disclosure relates generally to a cartridge for a vapour generating device configured to heat a vapour generating liquid to generate a vapour which cools and condenses to form an aerosol for inhalation by a user of the device. Embodiments of the present disclosure also relate to a vapour generating system comprising a vapour generating device and a cartridge configured to be used with the vapour generating device.

### TECHNICAL BACKGROUND

The term vapour generating device (or more commonly electronic cigarette or e-cigarette) refers to a handheld electronic device that is intended to simulate the feeling or experience of smoking tobacco in a traditional cigarette. Electronic cigarettes work by heating a vapour generating liquid to generate a vapour that cools and condenses to form an aerosol which is then inhaled by the user. Accordingly, using e-cigarettes is also sometimes referred to as “vaping”. The vapour generating liquid usually comprises nicotine, propylene glycol, glycerine, and flavourings.

Typical e-cigarette vaporizing units, i.e. systems or sub-systems for vaporizing the vapour generating liquid, utilize a cotton wick and heating element to produce vapour from liquid stored in a capsule or tank. When a user operates the e-cigarette, liquid that has soaked into the wick is heated by the heating element, producing a vapour which cools and condenses to form an aerosol which may then be inhaled. To facilitate the ease of use of e-cigarettes, cartridges are often used. These cartridges are often configured as “cartomizers”, which means an integrated component formed from a liquid store, a liquid transfer element (e.g. a wick) and a heater. Electrical connectors may also be provided to establish an electrical connection between the heating element and a power source. However, the complexity and numerous components of such cartridges are associated with drawbacks, such as a complex and costly manufacturing and/or assembly processes.

In view of the above, it would be desirable to provide a cartridge with improved manufacturability and/or assembly and which efficiently heats the vapour generating liquid.

### SUMMARY OF THE DISCLOSURE

According to a first aspect of the present disclosure, there is provided a cartridge for a vapour generating device, the cartridge comprising:
an inductively heatable susceptor; and
a porous liquid transfer element configured to convey vapour generating liquid to the inductively heatable susceptor, the porous liquid transfer element having a longitudinal axis and defining an airflow channel extending substantially in a longitudinal direction defined by the longitudinal axis, the porous liquid transfer element including a recess, wherein at least part of the inductively heatable susceptor is accommodated in the recess and at least part of the inductively heatable susceptor is accommodated in the airflow channel.

The cartridge is intended for use with a vapour generating device configured to heat the vapour generating liquid to volatise at least one component of the vapour generating liquid and thereby generate a vapour which cools and condenses to form an aerosol for inhalation by a user of the vapour generating device. The present disclosure is particularly applicable to a portable (hand-held) vapour generating device, which may be self-contained and low temperature

According to a second aspect of the present disclosure, there is provided a vapour generating system comprising a vapour generating device and a cartridge configured to be used with the vapour generating device, wherein:
the cartridge comprises:
   an inductively heatable susceptor; and
   a porous liquid transfer element configured to convey vapour generating liquid to the inductively heatable susceptor, the porous liquid transfer element having a longitudinal axis and defining an airflow channel extending substantially in a longitudinal direction defined by the longitudinal axis, the porous liquid transfer element including a recess, wherein at least part of the inductively heatable susceptor is accommodated in the recess and at least part of the inductively heatable susceptor is accommodated in the airflow channel;
the vapour generating device comprises an electromagnetic field generator positioned adjacent to the inductively heatable susceptor for inductively heating the inductively heatable susceptor.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

By accommodating at least part of the inductively heatable susceptor in the airflow channel, the inductively heatable susceptor is reliably secured in position in the recess in the porous liquid transfer element and the likelihood of the inductively heatable susceptor becoming dislodged is thereby reduced. This ensures that the inductively heatable susceptor is reliably positioned with respect to an electromagnetic field generator (e.g. an induction coil) of a vapour generating device, for example so that the inductively heatable susceptor is positioned concentrically with respect to the induction coil. This ensures that there is an optimum coupling between the inductively heatable susceptor and an alternating electromagnetic field generated by the induction coil which in turn ensures that the inductively heatable susceptor is reliably heated. By ensuring that the inductively heatable susceptor is reliably heated, vapour generation is maximised due to heating of the vapour generating liquid by the inductively heatable susceptor.

The cartridge may further comprise a liquid store for storing vapour generating liquid and the porous liquid transfer element may be configured to convey vapour generating liquid from the liquid store to the inductively heatable susceptor. The porous liquid transfer element may include an outer surface exposed to an inner space of the liquid store. Such an arrangement allows the vapour generating liquid in the liquid store to be readily absorbed by the outer surface of the porous liquid transfer element and to be conveyed to the inductively heatable susceptor by the porous liquid transfer element. Continuous and reliable vapour generation is thereby assured during use of the vapour generating device.

The outer surface may extend around an entire periphery of the porous liquid transfer element. Such an arrangement helps to ensure that a sufficient amount of vapour generating liquid is constantly conveyed by the porous liquid transfer element to the inductively heatable susceptor at all positions around the periphery of the porous liquid transfer element during use of the cartridge with a vapour generating device.

The recess may include a support surface which may support at least part of the inductively heatable susceptor. The support surface may be substantially orthogonal to the longitudinal axis and may extend substantially in the radial direction. The support surface may further help to ensure that the inductively heatable susceptor is reliably positioned with respect to an electromagnetic field generator (e.g. an induction coil) of a vapour generating device.

The inductively heatable susceptor may comprise a susceptor ring which may be accommodated in the recess. The inductively heatable susceptor may comprise pair of susceptor rings which may be spaced from each other in the longitudinal direction. The or each susceptor ring may include an inner circumferential edge. The or each susceptor ring may comprise one or more retaining elements which may extend from the inner circumferential edge into the airflow channel. The one or more retaining elements help to securely position the or each susceptor ring in the recess in the porous liquid transfer element, thus ensuring that the or each susceptor ring is optimally coupled with the alternating electromagnetic field generated by the electromagnetic field generator of a vapour generating device.

The one or more retaining elements may contact an inner surface of the airflow channel. The contact between the one or more retaining elements and the inner surface of the airflow channel may help to ensure that the inductively heatable susceptor is correctly and reliably positioned in the recess in the porous liquid transfer element and, thus, optimally coupled with the alternating electromagnetic field generated by the electromagnetic field generator of a vapour generating device.

The one or more retaining elements may comprise a circumferential lip or may comprise a tubular rim which may extend into airflow channel. Such an arrangement may further facilitate the positioning of the inductively heatable susceptor in the recess in the porous liquid transfer element, whilst at the same time providing a simple design with good manufacturability. Further, with these susceptor configurations, the circumferential lip or the tubular rim would also be inductively heated, thereby maximising vapour generation and minimising or preventing condensation formation in the airflow channel.

The one or more retaining elements may comprise a plurality of circumferentially spaced retaining legs which may extend into the airflow channel. Such an arrangement may further facilitate the positioning of the inductively heatable susceptor in the recess in the porous liquid transfer element. Also, the one or more retaining elements may tend to be heated conductively due to heat transfer from the inductively heated part of the inductively heatable susceptor that is supported by the support surface. Because of the positioning of the retaining elements in the airflow channel, some conductive heating inside the airflow channel is achieved thereby reducing the tendency for condensation to form in the airflow channel.

The inductively heatable susceptor may be substantially tubular and may be positioned inside the airflow channel to extend in the longitudinal direction along an inner surface of the airflow channel. The substantially tubular inductively heatable susceptor can be easily accommodated inside the airflow channel and may improve the manufacturability of the cartridge. This arrangement may also address the potential issue of condensation formation in the airflow channel (see above), whilst at the same time ensuring that efficient vapour generation takes place.

The tubular inductively heatable susceptor may include retaining elements at one or both longitudinal ends thereof. The retaining elements may extend outwardly and may be accommodated in the recess in the porous liquid transfer element. The retaining elements may be supported by the support surface of the recess. The retaining elements help to ensure that the substantially tubular inductively heatable susceptor is securely positioned inside the airflow channel of the porous liquid transfer element. During use, the tubular portion of the substantially tubular inductively heatable susceptor inside the airflow channel is inductively heated, whilst the retaining elements in the recess tend to be conductively heated by heat transferred from the tubular portion.

In a first example in which the tubular inductively heatable susceptor includes retaining elements at both longitudinal ends thereof, the retaining elements at both longitudinal ends may initially extend substantially in the longitudinal direction. Thus, the substantially tubular inductively heatable susceptor may be inserted into the airflow channel via the first or second longitudinal end, with the retaining elements at both longitudinal ends initially extending substantially in the longitudinal direction. After the substantially tubular inductively heatable susceptor has been fully inserted into the airflow channel, the retaining elements at both longitudinal ends can be bent or splayed outwardly into engagement with the support surface of the corresponding recess.

In a second example in which the tubular inductively heatable susceptor includes retaining elements at both longitudinal ends thereof, the retaining elements at a first longitudinal end may initially extend substantially in the longitudinal direction and the retaining elements at a second, opposite, longitudinal end may extend outwardly in the radial direction. The substantially tubular inductively heatable susceptor may be inserted into the airflow channel via its first longitudinal end until the retaining elements at the second longitudinal end enter into engagement with the support surface of the corresponding recess. The retaining elements at the first longitudinal end can then be bent or splayed outwardly into engagement with the support surface of the other recess.

The inductively heatable susceptor may include at least one first interference fit element and the porous liquid transfer element may include at least one second interference fit element which may cooperate with the at least one first interference fit element. The first and second interference fit elements may provide a mechanical snap-fit connection between the inductively heatable susceptor and the porous liquid transfer element. The inductively heatable susceptor is thus reliably secured in position in the recess in the porous liquid transfer element. As the inductively heatable susceptor is pushed or pressed into position in the recess of the porous liquid transfer element, the inductively heatable susceptor may tend to flex or deform by a small amount until the cooperating first and second interference fit elements enter registry. At this point, the inductively heatable susceptor snaps into engagement with the porous liquid transfer element and is held securely and reliably in position with a good fit against the mating surface, i.e., the support surface, of the recess formed in the porous liquid transfer element.

The first and second interference fit elements may define a camming profile in a first direction. This may facilitate positioning of the inductively heatable susceptor in the recess and the airflow channel of the porous liquid transfer element, for example by facilitating the aforementioned flexing or deformation of the inductively heatable susceptor as it is pushed into position in the recess of the porous liquid transfer element.

The first and second interference fit elements may define a non-camming locking profile in a second direction opposite to the first direction. This may impede removal of the inductively heatable susceptor from the recess and the airflow channel and/or prevent it from becoming dislodged from the recess and the airflow channel.

In one embodiment, the first interference fit element may be formed on or in the inductively heatable susceptor and the second interference fit element may be formed on or in the support surface. In another embodiment, at least one of said first interference fit elements may be formed on or in at least one of the circumferentially spaced retaining legs and one or more of said second interference fit elements may be formed on or in the inner surface of the airflow channel.

The inductively heatable susceptor, the porous liquid transfer element and the airflow channel may all be arranged in coaxial alignment about the longitudinal axis. A simplified cartridge structure may thereby be achieved, contributing to improved manufacturability of the cartridge.

The inductively heatable susceptor may be fluid-permeable. As used herein, the term “fluid permeable” means an inductively heatable susceptor that allows a liquid or gas to permeate through it. For example, the fluid permeable inductively heatable susceptor may include a plurality of openings or perforations or may have an open-porous structure which allows fluid to permeate through it. In particular, the fluid permeable inductively heatable susceptor allows the vapour generating liquid or the resulting vapour generated by heating the vapour generating liquid to permeate through it.

The porous liquid transfer element may comprise a capillary material. The capillary material may comprise a porous ceramic material. The porous liquid transfer element contacts the vapour generating liquid to enable absorption of the vapour generating liquid by the capillary material, for example due to capillary action or wicking, and conveys the absorbed vapour generating liquid to the inductively heatable susceptor where it is heated to form a vapour.

The vapour generating liquid may comprise polyhydric alcohols and mixtures thereof such as glycerine or propylene glycol. The vapour generating liquid may contain nicotine and may, therefore, be designated a nicotine-containing liquid. The vapour generating liquid may contain one or more additives, such as a flavouring.

The electromagnetic field generator may comprise an induction coil arranged to generate an alternating electromagnetic field for inductively heating the inductively heatable susceptor.

The induction coil may comprise a Litz wire or a Litz cable. It will, however, be understood that other materials could be used.

The inductively heatable susceptor may comprise one or more, but not limited, of aluminium, iron, nickel, stainless steel, copper, and alloys thereof, e.g. Nickel Chromium or Nickel Copper. With the application of an alternating electromagnetic field in its vicinity, for example generated by the electromagnetic field generator, the susceptor may generate heat due to eddy currents and magnetic hysteresis losses resulting in a conversion of energy from electromagnetic to heat.

The electromagnetic field generator may be arranged to operate in use with a fluctuating electromagnetic field having a magnetic flux density of between approximately 20 mT and approximately 2.0 T at the point of highest concentration.

The vapour generating device may include a power source and may include circuitry. The power source and circuitry may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The inductively heatable susceptor and the porous liquid transfer element may form a vapour generating unit. The vapour generating unit can be manufactured as a subassembly, thereby leading to improved manufacturability of the cartridge.

The cartridge may comprise a closure for sealing the liquid store. The closure may comprise a recess which may support the vapour generating unit. The vapour generating unit is thereby reliably supported in a desired position.

The closure may include at least one air inlet for conveying air to the vapour generating unit. A reliable airflow to the vapour generating unit is thereby assured, in turn ensuring that vapour is efficiently generated.

### BRIEF DESCRIPTION OF THE DRAWINGS

FIG. 1 is a diagrammatic cutaway perspective view of a first example of a cartridge for a vapour generating device;

FIG. 2 is a diagrammatic cutaway side view of the cartridge of FIG. 1;

FIG. 3a is a diagrammatic cutaway perspective view of a first example of a vapour generating unit of the cartridge illustrated FIGS. 1 and 2;

FIG. 3b is a diagrammatic cutaway perspective view of second example of a vapour generating unit;

FIG. 3c is a diagrammatic cross-sectional view of a third example of a vapour generating unit which is a variation of the first example shown in FIG. 3a;

FIG. 3d is a diagrammatic cross-sectional view of a fourth example of a vapour generating unit which is a variation of the first example shown in FIG. 3a;

FIG. 4 is a diagrammatic view of a pair of inductively heatable susceptors of the vapour generating unit of FIG. 3a in an ‘unrolled’ state;

FIG. 5 is a diagrammatic plan view an inductively heatable susceptor of FIGS. 3a and 4 prior to mounting on a porous liquid transfer element;

FIG. 6 is a diagrammatic perspective view of a sub-assembly comprising the vapour generating unit illustrated in FIG. 3a and sealing members;

FIG. 7 is diagrammatic perspective top view a closure of the cartridge illustrated FIGS. 1 and 2;

FIG. 8 is a diagrammatic cutaway perspective view of a second example of a cartridge for a vapour generating device;

FIG. 9 is a diagrammatic cutaway side view of the cartridge of FIG. 8;

FIG. 10 is a diagrammatic cutaway perspective view of a vapour generating unit of the cartridge illustrated FIGS. 8 and 9;

FIG. 11 is a diagrammatic perspective view of a sub-assembly comprising the vapour generating unit illustrated in FIG. 10 and sealing members; and

FIG. 12 is a diagrammatic view of a vapour generating system comprising a vapour generating device and a cartridge.

### DETAILED DESCRIPTION OF EMBODIMENTS

Embodiments of the present disclosure will now be described by way of example only and with reference to the accompanying drawings.

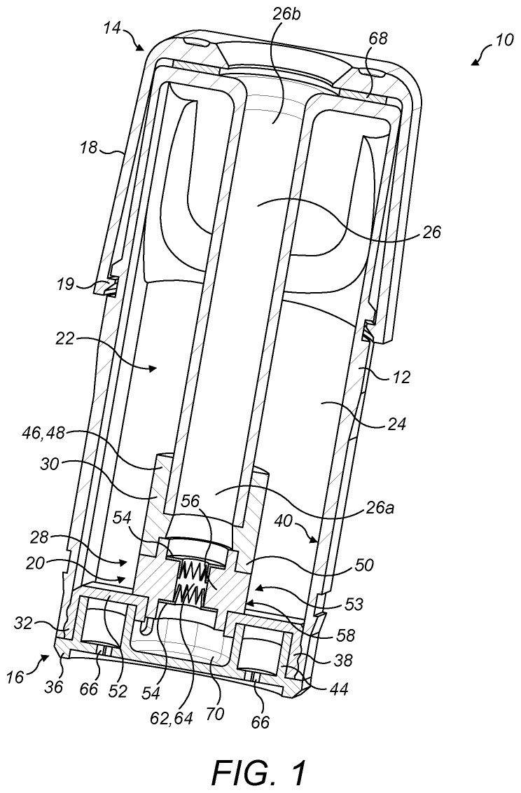

Referring initially to FIGS. 1 to 7, there is shown a first example of a cartridge 10 according to the present disclosure. The cartridge 10 is configured to be used with a vapour generating device 100 as shown diagrammatically in FIG. 12. The vapour generating device 100 comprises a power source (e.g. a battery) 102 and circuitry 104, such that the cartridge 10 and the vapour generating device 100 together form a vapour generating system 106. In an embodiment, the cartridge 10 is releasably connectable to the vapour generating device 100 by a releasable connection 110. The releasable connection 110 can, for example, be a snap-fit connection or alternatively a threaded connection or a bayonet connection.

The cartridge 10 comprises a cartridge housing 12 having a proximal end 14 and a distal end 16. The proximal end 14 may constitute a mouthpiece end configured for being introduced directly into a user's mouth and may, therefore, also be designated as the mouth end 14. In the illustrated example, a mouthpiece 18 is fitted to the proximal (mouth) end 14 and is secured in position on the cartridge housing 12 by a snap-fit connection 19. The cartridge 10 comprises a base portion 20 and a liquid storage portion 22. The liquid storage portion 22 comprises a liquid store 24, configured for containing therein a vapour generating liquid, and a vapour outlet channel 26 having an outlet 26b at the proximal (mouth) end 14. The vapour generating liquid may comprise an aerosol-forming substance such as propylene glycol and/or glycerol and may contain other substances such as nicotine and acids. The vapour generating liquid may also comprise flavourings such as e.g. tobacco, menthol, or fruit flavour. The liquid store 24 may extend generally between the proximal (mouth) end 14 and the distal end 16. The liquid store 24 may surround, and coextend with, the vapour outlet channel 26.

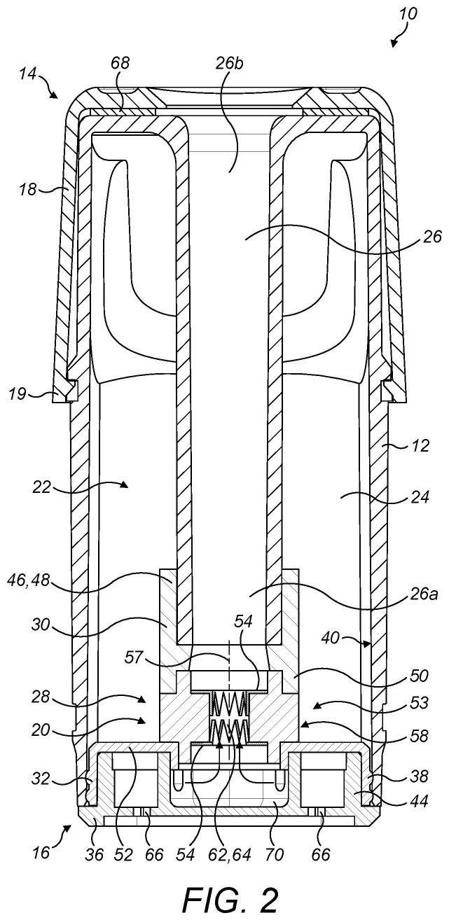

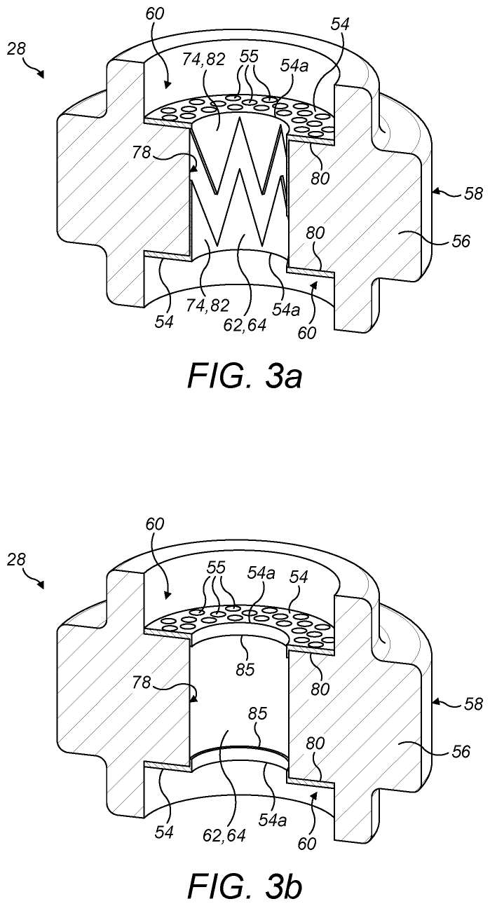

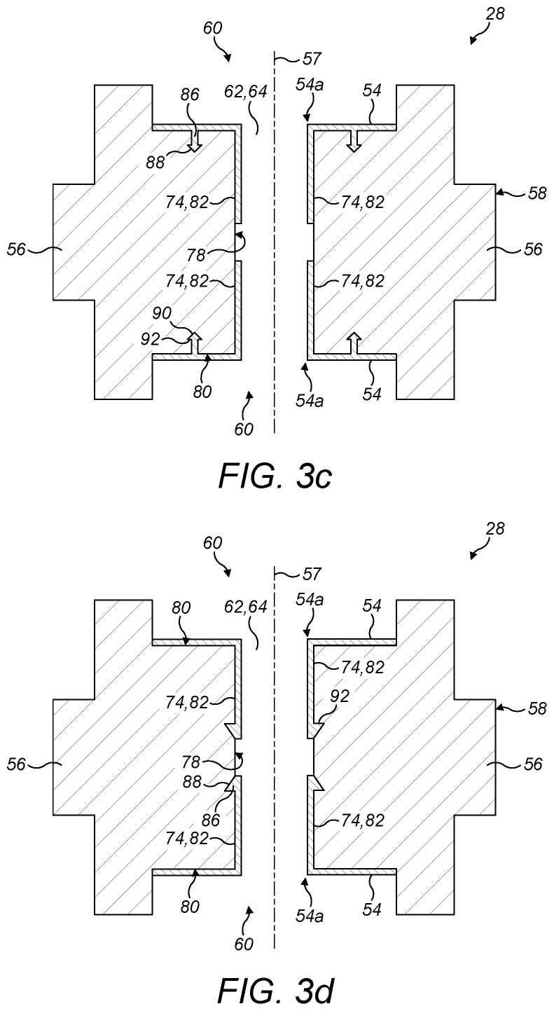

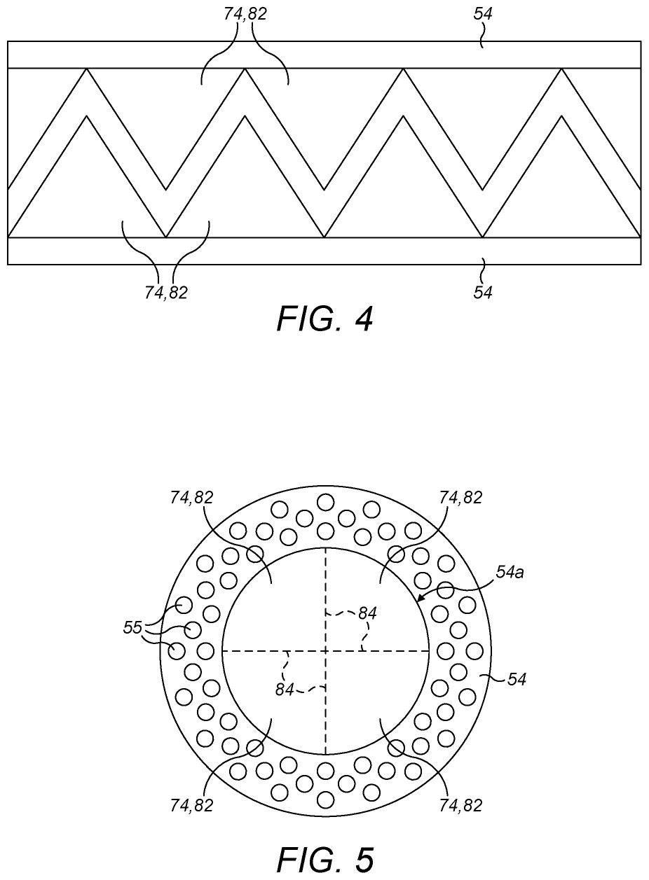

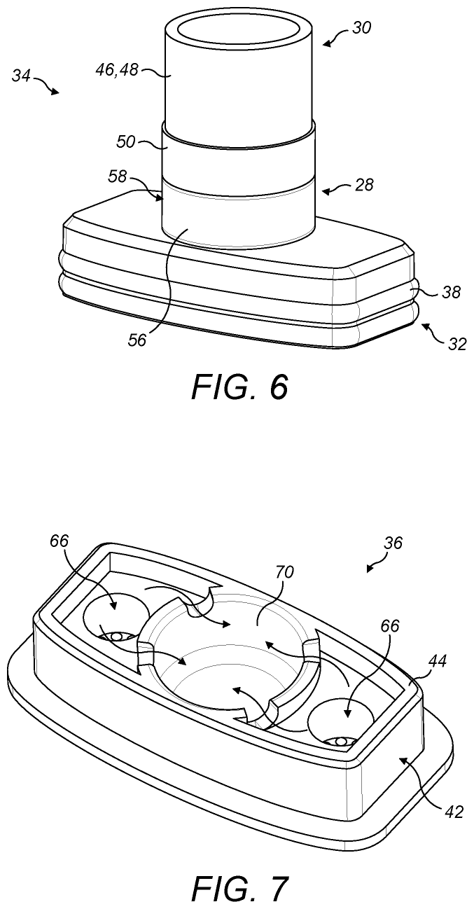

As best seen in FIGS. 1 and 2, the base portion 20 of the cartridge 10 may be configured to sealingly close off the distal end 16 of the cartridge 10. The base portion 20 comprises a vapour generating unit 28 best seen in FIGS. 3 and 4, upper and lower sealing members 30, 32 which, together with the vapour generating unit 28, form a subassembly 34 as shown in FIG. 6, and a closure 36 shown separately in FIG. 7. The subassembly 34 and closure 36 are positioned at the distal end 16 of the cartridge housing 12, and more particularly in the space formed between the liquid store 24 and the distal end 16. The subassembly 34 and closure 36 cooperate to close the distal end 16 of the cartridge housing 12 and thereby retain the vapour generating liquid in the liquid store 24. The subassembly 34 can be conveniently accommodated in, and supported by, a centrally positioned recess 70 in the closure 36 (see FIG. 7) which may facilitate the assembly of the cartridge 10 and ensure the correct positioning of the vapour generating unit 28 at the distal end 16 of the cartridge housing 12.

The lower sealing member 32 is provided with an outer sealing portion 38 that is in contact on one side with an inner surface 40 of the liquid store 24 at the distal end 16 of the cartridge housing 12 and on an opposite side with an outwardly facing surface 42 of a peripheral skirt 44 of the closure 36. The lower sealing member 32 may be formed of a material with an inherent elasticity that provides a sealing effect when the outer sealing portion 38 contacts the inner surface 40 of the liquid store 24 and the outwardly facing surface 42 of the peripheral skirt 44. For example, the lower sealing member 32 may comprise rubber or silicone.

The upper sealing member 30 comprises a connecting portion 46 which is configured to sealingly connect to a distal end 26a of the vapour outlet channel 26. The connecting portion 46 includes an annular flange 48 configured to seal against the outer circumferential surface of the vapour outlet channel 26 at the distal end 26a. The upper sealing member 30 may be formed of the same material as the lower sealing member 32.

The upper and lower sealing members 30, 32 include respectively upper and lower sealing portions 50, 52 which define therebetween a cavity 53 in which the vapour generating unit 28 is accommodated. The upper and lower sealing portions 50, 52 are configured to sealingly engage the vapour generating unit 28 as can be seen clearly in FIGS. 1, 2 and 6.

The vapour generating unit 28 comprises an inductively heatable susceptor in the form of susceptor rings 54, and a porous liquid transfer element 56 having a longitudinal axis 57. The susceptor rings 54 are spaced apart along the longitudinal axis 57 and the porous liquid transfer element 56 is configured to convey vapour generating liquid from the liquid store 24 to the susceptor rings 54 so that the vapour generating liquid can be heated and vaporized.

The porous liquid transfer element 56 comprises a capillary material, such as a porous ceramic material, and includes an outer surface 58 which extends around the entire periphery of the liquid transfer element 56 and which is exposed to an inner space of the liquid store 24 in the region formed between the upper and lower sealing portions 50, 52. Vapour generating liquid is absorbed into the porous liquid transfer element 56 via the outer surface 58 and is conveyed, for example by a wicking action, to the susceptor rings 54 so that the vapour generating liquid can be heated and vaporized. The porous liquid transfer element 56 includes at least one recess 60, and in the illustrated example two longitudinally spaced recesses 60 formed in upper and lower ends, which accommodate the susceptor rings 54. The susceptor rings 54 are typically arranged in coaxial alignment with the porous liquid transfer element 56.

The susceptor rings 54 comprise an inductively heatable material so that, when the susceptor rings 54 are exposed to an alternating and time-varying electromagnetic field generated by an electromagnetic field generator 108 (e.g. an induction coil) of a vapour generating device 100 (see FIG. 12), eddy currents and/or magnetic hysteresis losses are generated in the susceptor rings 54 causing them to heat up. The heat is transferred from the susceptor rings 54 to the vapour generating liquid absorbed by the porous liquid transfer element 56, for example by conduction, radiation, and convection, thereby heating and vaporizing the vapour generating liquid.

The porous liquid transfer element 56 defines an airflow channel 62 that extends substantially in the longitudinal direction parallel to the longitudinal axis 57. The airflow channel 62 defines a substantially cylindrical vaporization chamber 64 which is aligned with, and fluidly connected to, the vapour outlet channel 26 and in particular to the distal end 26a. The vaporization chamber 64 thus provides a route which allows vapour generated by heating the vapour generating liquid absorbed by the porous liquid transfer element 56 to be transferred into the vapour outlet channel 26 where it cools and condenses to form an aerosol that can be inhaled by a user via the mouthpiece 18 at the proximal (mouth) end 14. The susceptor rings 54 have an open-porous structure which allows the vapour generating liquid from the liquid store 24 and/or the generated vapour to permeate through them, into the vaporization chamber 64. As an alternative to an open-porous structure, the susceptor rings 54 could include a plurality of openings or perforations 55, as shown in FIG. 3.

In operation, vapour generating liquid is absorbed by the porous liquid transfer element 56 via the outer surface 58 and conveyed to the susceptor rings 54. As noted above, when the cartridge 10 is used with a vapour generating device 100 including an electromagnetic field generator 108, the susceptor rings 54 are inductively heated by the electromagnetic field generator 108. The heat from the susceptor rings 54 is transferred to vapour generating liquid absorbed by the porous liquid transfer element 56, resulting in the generation of a vapour. The vapour escapes from the porous liquid transfer element 56 into the vaporization chamber 64, and then flows from the vaporization chamber 64 along the vapour outlet channel 26 where it cools and condenses to form an aerosol that is inhaled by a user through the mouthpiece 18. The vaporization of the vapour generating liquid is facilitated by the addition of air from the surrounding environment through air inlets 66 formed in the closure 36. The flow of air and/or vapour through the cartridge 10, i.e. from the air inlets 66, through the vaporization chamber 64, along the vapour outlet channel 26, and out of the mouthpiece 18, is aided by negative pressure created by a user drawing air from the proximal (mouth) end 14 using the mouthpiece 18. As best seen in FIGS. 1 and 2, a mouthpiece seal 68 is located between the mouthpiece 18 and the cartridge housing 12 to provide a seal between these two components.

Referring in particular to FIG. 3a, it can be seen that the recesses 60 in which the susceptor rings 54 are accommodated each have a support surface 80 which is configured to support the susceptor rings 54 and which is substantially orthogonal to the longitudinal axis 57 of the porous liquid transfer element 56. Each susceptor ring 54 includes an inner circumferential edge 54a and a plurality of retaining elements 74 which extend from the circumferential edge 54a into the airflow channel 62. The retaining elements 74 comprise a plurality of circumferentially spaced retaining legs 82 which can have a generally triangular shape as illustrated. A triangular shape may be advantageous because it allows the retaining legs 82 of the spaced upper and lower susceptor rings 54 to be intermeshed. This is shown diagrammatically in FIG. 4, where the upper and lower susceptor rings 54 are illustrated artificially in an ‘unrolled’ state. The retaining legs 82 contact an inner surface 78 of the airflow channel 62 to ensure that the upper and lower susceptor rings 54 are securely retained in position in the respective recesses 60 in the porous liquid transfer element 56.

FIG. 5 shows one of the susceptor rings 54 of FIG. 3a prior to location in the recess 60. The susceptor ring 54 can be formed from a sheet of inductively heatable susceptor material which can be perforated using any suitable technique to provide perforation lines 84 that define the retaining legs 82. A suitable technique includes laser scoring or stamping using a press. Initially, the retaining legs 82 are coplanar with the susceptor ring 54. After positioning the susceptor ring 54 in the recess 60 so that it is supported by the support surface 80, the retaining legs 82 can be bent (e.g. using a mandrel or similar tool) about the inner circumferential edge 54a of the susceptor ring 54 so that they extend into the airflow channel 62 and contact the inner surface 78 as best seen in FIG. 3a.

In an alternative example shown in FIG. 3b, the susceptor rings 54 can include a circular lip 85 (or a tubular rim 85) formed about the inner circumferential edge 54a which extends into the airflow channel 62 and contacts the inner surface 78.

Referring to FIG. 3c, in a variation of the arrangement shown in FIG. 3a, each of the susceptor rings 54 can include a first interference fit element 86 in the form of circumferentially-extending ridge and the porous liquid transfer element 56 can include a second interference fit element 88 in the form of a corresponding circumferentially-extending groove formed in the support surface 80. The first and second interference fit elements 86, 88 provide a mechanical snap-fit connection between each susceptor ring 54 and the porous liquid transfer element 56, thus ensuring that each susceptor ring 54 is securely retained in position in the corresponding recess 60 in the porous liquid transfer element 56. It should be noted that the first and second interference fit elements 86, 88 could also be applied to the arrangement shown in FIG. 3b with the circular lip 85 or tubular rim 85.

Where present, the optional first and second interference fit elements 86, 88 define a camming profile 90 in a first (mounting) direction and define a non-camming locking profile 92 in a second direction opposite to the first direction. Thus, as each of the susceptor rings 54 is pushed or pressed into position on the corresponding support surface 80, the susceptor ring 54 tends to flex by a small amount until the first and second interference fit elements 86, 88 enter registry. At this point, each of the susceptor rings 54 snaps into engagement with the porous liquid transfer element 56 and is held securely and reliably in position with a good fit against the support surface 80. It will be understood by one of ordinary skill in the art that the first and second interference fit elements 86, 88 can have any suitable geometry (e.g. nodules and indentations).

Referring to FIG. 3d, in another variation of the arrangement shown in FIG. 3a, one or more of the retaining legs 82 can include a first interference fit element 86 and the inner surface 78 of the airflow channel 62 can include a second interference fit element 88. In this example, each of the optional first and second interference fit elements 86, 88 can define a non-camming locking profile 92 in a second direction opposite to a first (mounting) direction. It should again be noted that the first and second interference fit elements 86, 88 could also be applied to the arrangement shown in FIG. 3b, and in particular to the circular lip 85 or the tubular rim 85.

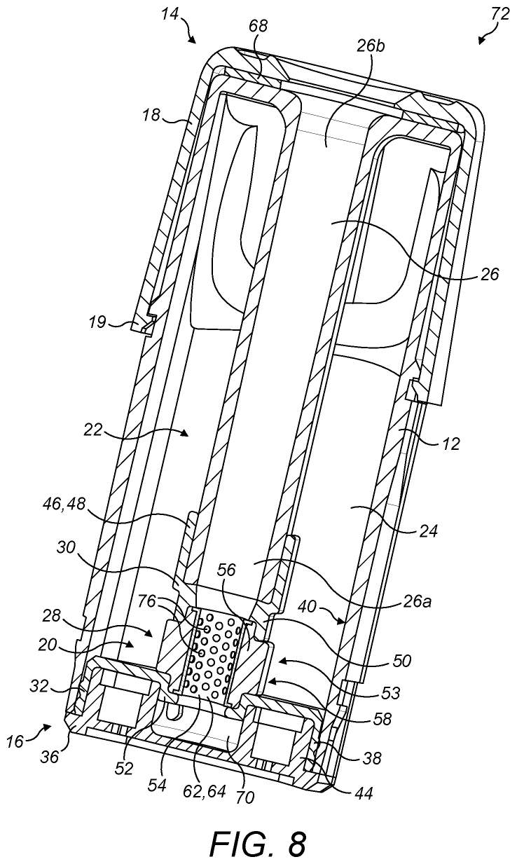

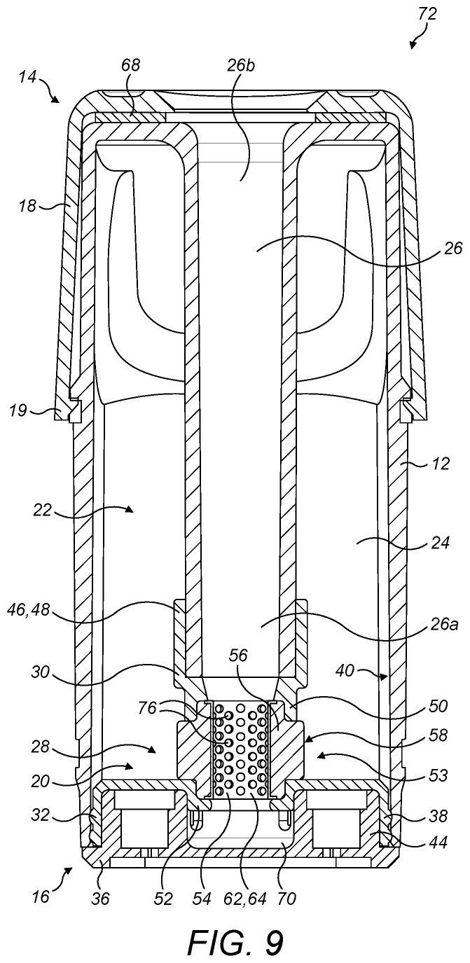

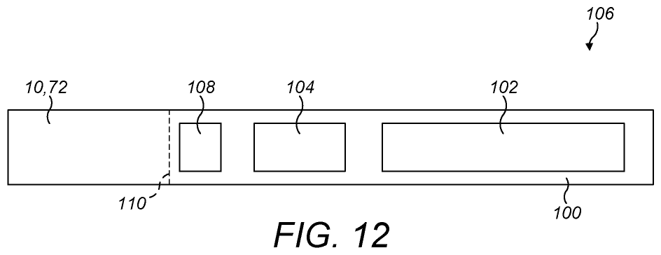

Referring now to FIGS. 8 to 11, there is shown a second example of a cartridge 72 according to the present disclosure. The cartridge 72 is similar to the cartridge 10 described above with reference to FIGS. 1 to 7 and corresponding elements are designated using the same reference numerals. The cartridge 72 is also configured for use with a vapour generating device 100 as described above with reference to FIG. 12 such that the cartridge 72 and vapour generating device 100 together form a vapour generating system 106.

In the second example, and as best seen in FIGS. 8 to 10, the inductively heatable susceptor 54 is substantially tubular. Part of the tubular inductively heatable susceptor 54 is positioned inside the airflow channel 62, that is inside the substantially cylindrical vaporization chamber 64, so that it extends longitudinally (substantially parallel to the longitudinal axis 57) along an inner surface 78 of the airflow channel 62. In order to allow the flow of vapour generating liquid and/or vapour from the porous liquid transfer element 56 into the vaporization chamber 64, the tubular inductively heatable susceptor 54 includes a plurality of perforations 76.

The tubular inductively heatable susceptor 54 includes retaining elements 74 at both longitudinal ends which are accommodated in corresponding longitudinally spaced recesses 60 formed in upper and lower ends of the porous liquid transfer element 56, and thus it can be considered that part of the tubular inductively heatable susceptor 54 is also positioned in the recesses 60. The retaining elements 74 are circumferentially spaced and extend outwardly into the corresponding recess 60 so that they contact, and are supported by, the support surface 80 of the corresponding recess 60. The retaining elements 74 help to secure the tubular inductively heatable susceptor 54 in position inside the airflow channel 62 of the porous liquid transfer element 56 by preventing movement in the longitudinal direction. During use of the cartridge 72 with a vapour generating device 100, the tubular portion of the tubular inductively heatable susceptor 54 inside the airflow channel 62 is inductively heated, whilst the retaining elements 74 positioned in the recesses 60 are conductively heated by heat transferred from the inductively heated tubular portion.

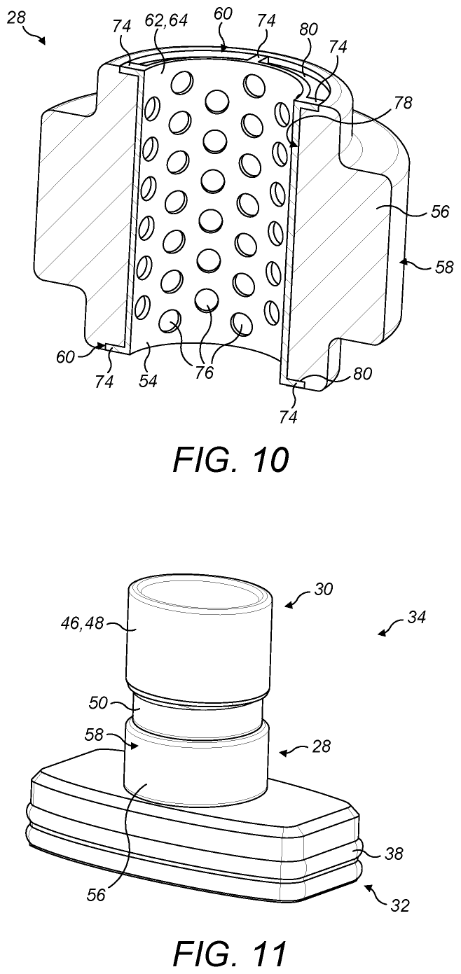

When the tubular inductively heatable susceptor 54 includes retaining elements 74 at both longitudinal ends as best seen in FIG. 10, the retaining elements 74 at both longitudinal ends can initially extend substantially in the longitudinal direction, thus allowing the tubular inductively heatable susceptor 54 to be inserted into the airflow channel 62 via the first or second longitudinal end. After the tubular inductively heatable susceptor 54 has been inserted into the airflow channel 62, the retaining elements 74 at both longitudinal ends can be bent or splayed outwardly into engagement with the respective support surface 80 of the corresponding recess 60.

Alternatively, the retaining elements 74 at only one of the longitudinal ends (e.g., the first longitudinal end) may initially extend substantially in the longitudinal direction and the retaining elements 74 at the opposite longitudinal end (e.g., the second longitudinal end) may already extend outwardly. In this case, tubular inductively heatable susceptor 54 is inserted into the airflow channel 62 via its first longitudinal end until the retaining elements 74 at the second longitudinal end engage the support surface 80 of the corresponding recess 60. The retaining elements 74 at the first longitudinal end can then be bent or splayed outwardly into engagement with the support surface 80 of the other recess 60.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A cartridge (10, 72) for a vapour generating device (100), the cartridge comprising:
an inductively heatable susceptor (54); and
a porous liquid transfer element (56) configured to convey vapour generating liquid to the inductively heatable susceptor (54), the porous liquid transfer element (56) having a longitudinal axis (57) and defining an airflow channel (62) extending substantially in a longitudinal direction defined by the longitudinal axis (57), the porous liquid transfer element (56) including a recess (60), wherein at least part of the inductively heatable susceptor (54) is accommodated in the recess (60) and at least part of the inductively heatable susceptor (54) is accommodated in the airflow channel (62).

2. A cartridge according to claim 1, wherein the recess (60) includes a support surface (80) which supports at least part of the inductively heatable susceptor (54).

3. A cartridge according to claim 2, wherein the support surface (80) is substantially orthogonal to the longitudinal axis (57) and extends substantially in the radial direction.

4. A cartridge according to any preceding claim, wherein the inductively heatable susceptor (54) comprises:
a susceptor ring (54) accommodated in the recess (60) and including an inner circumferential edge (54a); and
one or more retaining elements (74) extending from the inner circumferential edge (54a) into the airflow channel (62).

5. A cartridge according to claim 4, wherein the one or more retaining elements (74) contact an inner surface (78) of the airflow channel (62).

6. A cartridge according to claim 4 or claim 5, wherein the one or more retaining elements (74) comprise a circumferential lip (85) or a tubular rim (85) extending into airflow channel (62).

7. A cartridge according to claim 4 or claim 5, wherein the one or more retaining elements (74) comprise a plurality of circumferentially spaced retaining legs (82) extending into the airflow channel (62).

8. A cartridge according to any of claims 1 to 3, wherein the inductively heatable susceptor (54) is substantially tubular and positioned inside the airflow channel (62) to extend in the longitudinal direction along an inner surface (78) of the airflow channel (62).

9. A cartridge according to claim 8, wherein the tubular inductively heatable susceptor (54) includes retaining elements (74) at one or both longitudinal ends thereof, the retaining elements (74) extend outwardly and are accommodated in the recess (60) in the porous liquid transfer element (56).

10. A cartridge according to claim 9 when dependent on claim 2 or claim 3, wherein the one or more retaining elements (74) are supported by the support surface (80) of the recess (60).

11. A cartridge according to any preceding claim, wherein the inductively heatable susceptor (54) includes at least one first interference fit element (86) and the porous liquid transfer element (56) includes at least one second interference fit element (88) which cooperates with the at least one first interference fit element (86), preferably wherein the first and second interference fit elements (86, 88) provide a mechanical snap-fit connection between the inductively heatable susceptor (54) and the porous liquid transfer element (56).

12. A cartridge according to claim 11, wherein the first and second interference fit elements (86, 88) define a camming profile (90) in a first direction to facilitate positioning of the inductively heatable susceptor (54) in the recess (60) and the airflow channel (62) of the porous liquid transfer element (56).

13. A cartridge according to claim 12, wherein the first and second interference fit elements (86, 88) define a non-camming locking profile (92) in a second direction opposite to the first direction to impede removal of the inductively heatable susceptor (54) from the recess (60) and the airflow channel (62).

14. A cartridge according to any preceding claim, wherein the inductively heatable susceptor (54), the porous liquid transfer element (56) and the airflow channel (62) are all arranged in coaxial alignment about the longitudinal axis (57).

15. A cartridge according to any preceding claim, wherein the inductively heatable susceptor (54) is fluid-permeable.

16. A cartridge according to any preceding claim, wherein the porous liquid transfer element (56) comprises a capillary material, preferably wherein the capillary material comprises a porous ceramic material.
